(19) United States
(12) Patent Application Publication
(10) Pub. No.: US 2009/0278921 A1
(43) Pub. Date: Nov. 12, 2009

(54) Image Stabilization of Video Play Back

(75) Inventor: Gordon Wilson, San Francisco, CA (US)

Correspondence Address: Blairtech Solution LLC, 1039 Merritt Terrace, Sunnyvale, CA, 94086, US

(73) Assignee: CAPSO VISION, INC., Saratoga, CA (US)

(21) Appl. No.: 12/464,270

(22) Filed: May 12, 2009

Related U.S. Application Data
(60) Provisional application No. 61/052,591, filed on May 12, 2008.

(51) Int. Cl. H04N 7/18; H04N 5/228

(52) U.S. Cl. 348/77; 348/208.4; 348/E05.031; 348/E07.085

(57) ABSTRACT

Systems and methods are provided for compensating motion fluctuation and luminance in video data from a capsule camera system. The capsule camera system moves through the GI tract under the action of peristalsis and records images of the intestinal walls. The gut itself contracts and expands but exhibits little net movement. The capsule's movement is episodic and jerky. It typically pitches, rolls, and yaws. Its average motion is forward, but it also moves backward and from side to side along the way. Luminance fluctuation and other luminance artifacts also exist in the captured capsule video. Motion and luminance compensation for the capsule video will improve the visual quality of the compensated video.

### CROSS REFERENCE TO RELATED APPLICATIONS

The present invention is related and claims priority to U.S. Provisional Patent Application, Ser. No. 61//052,591 entitled “Image Stabilization of Video Play Back” and filed on May 12, 2008. The U.S. Provisional Patent Application is hereby incorporated by reference in its entireties.

### FIELD OF THE INVENTION

The present invention relates to diagnostic imaging inside the human body. In particular, the present invention relates to stabilizing motion fluctuation in a video data captured by a capsule camera system.

### BACKGROUND

Image stabilization improves the playback viewability of video recorded with a moving camera. Ideally, the camera would be mechanically stabilized against shaking. The camera might also employ image stabilization within the camera, for example by moving the image sensor relative to the lens or by actuating a beam-deflecting element, such as a prism, to compensate for camera motion that is detected by gyrometers. However, in many cases, image stabilization during video recording may not be adequate, practical, or available. In these cases, image stabilization is still possible during playback, particularly if the image activity (motion of features within the image) due to camera movement was comparable to or greater than the activity due to the movement of objects in the recorded scene. One example is the recording of scenery from a Jeep on a bumpy dirt road. Another example is the recording of in vivo images by a capsule camera. Image stabilization on playback seeks to move and warp an image, relative to an image field in which it resides, so that the motion of content (i.e. features or objects) within the image is stabilized or damped, relative to the image field.

The capsule camera moves through the GI tract under the action of peristalsis and records images of the intestinal walls. The gut itself contracts and expands but exhibits little net movement. The capsule's movement is episodic and jerky. It typically pitches, rolls, and yaws. Its average motion is forward, but it also moves backward and from side to side along the way. The resulting video can be quite jerky.

During playback, the diagnostician wishes to find polyps or other points of interest as quickly and efficiently as possible. The video may have been captured over a period of 4-14 hours at a frame rate of 2-4 fps. The playback is at a controllable frame rate and may be increased to reduce viewing time. However, if the frame rate is increased too much, the gyrations of the field of view (FOV) will make the video stream difficult to follow. At whatever frame rate, image gyration demands more cognitive effort on the diagnostician's part to follow, resulting in viewer fatigue and increased chance of missing important information in the video.

Because the frame rate is low relative to standard video (e.g. 30 fps) the frame-to-frame camera motion may be large. Additionally, the capsule camera may employ motion detection and only store those frames judged to be different than previously stored frames by a threshold amount. With this algorithm applied, the frame-to-frame motion is virtually assured to be significant.

U.S. Pat. No. 7,119,837, entitled “Video Processing System and Method for Automatic Enhancement of Digital Video”, discloses a means for stabilizing video. Global alignment affine transforms are computed on a frame sequence, optic flow vectors are calculated, the video is de-interlaced using optic flow vectors, and the de-interlaced video is warp-stabilized by inverting or damping the global motion using the global alignment transforms. The warping produces fluctuations in the image boundary so that gaps appear between the image and the image frame. These gaps are filled in by using optical flow to stitch across frames.

While U.S. Pat. No. 7,119,837 discloses an invention to enhance video quality by stabilizing video jitter due to camera movement, the technique may not be suited for video data from a capsule camera system because the capsule video presents very different characteristics from the video taken by a consumer camcorder. The capsule camera images the GI tract at a close distance and the capture images often are noticeably distorted. It is desirable to have a method and system that effectively compensates the motion fluctuation in capsule video.

The capsule video is always captured under a distinct illumination condition from the video taken from a consumer camcorder. It is dark inside the GI tract and LED or similar lighting is always required to provide adequate lighting. The characteristics of the organ to be imaged and the structure of the camera lens and the LEDs will create various undesired luminance artifacts. It is desired to have a method and system to effectively reduce these artifacts.

### SUMMARY

The present invention provides an effective method and system to compensate, during video play back, the motion fluctuation and luminance fluctuation and artifacts in the video data from a capsule camera system. The method produces a processed capsule video that is motion and luminance stabilized to help a diagnostician find polyps or other points of interest as quickly and efficiently as possible.

Due to the particular imaging condition in the GI tract, a unique motion algorithm is disclosed in this invention where a tubular object model is employed to approximate the surface of the organ to be imaged. The surface is modeled as a tube of circular cross section with a radius ρ. This tubular object module is then used with global and local motion estimation algorithms to achieve a best estimate of parameters of motion fluctuation. The estimated parameters of motion fluctuation are used to compensate the motion fluctuation.

In one embodiment, a method for compensating motion fluctuation in video data from a capsule camera system is disclosed, wherein the method comprises receiving the video data generated by the capsule camera system, arranging the received video data, estimating parameters of the motion fluctuation of the arranged video data based on a tubular object model, compensating the motion fluctuation of the arranged video data using the parameters of the motion fluctuation, and providing the motion compensated video data as a video data output.

In one embodiment of the invention, a local motion estimation algorithm is initially applied to the video data to compute local motion vectors. A global motion estimation algorithm then uses the estimated local motion vectors and the tubular object model to derive global motion parameters, which is also termed global motion transform in this invention. Some local motion vectors (outliers) may be excluded from the derivation of the global motion transform. The global motion transforms use a single set of parameters to describe the corresponding pixels movement between a frame and a reference frame. The global motion transform should result in a more reliable and stable motion estimation matched to the camera movement.

In another embodiment of the invention, the global motion transform computed is used to refine the local motion vectors with the assistance of the tubular object model and the refined local motion vectors are, in turn, used to update the global motion transform. Some refined local motion vectors may be excluded from the computation of updating the global motion transform. The above refining and updating process is iterated until a stop criterion is satisfied.

The capsule video is also subject to luminance fluctuation and various luminance artifacts. Upon the completion of compensation for motion fluctuation, the motion compensated video data may be further processed to alleviate the luminance fluctuation and/or various luminance artifacts. In one embodiment, the average or median luminance for each block of the frame is computed, where saturated pixels and nearest neighbors are excluded form the computation. A temporal low pass filter is then applied to corresponding blocks over a plurality of frames to obtain a smoothed version of the luminance blocks. A luminance compensation function is calculated based on the block luminance and smoothed block luminance and the luminance compensation function is then used to compensate the block luminance accordingly. As will be understood by those skilled in the art, many different algorithms are possible to cause similar effect for luminance compensation.

In another embodiment, various luminance artifacts are also corrects where the artifacts may be transient exposure defects or specular reflects.

### BRIEF DESCRIPTION OF THE DRAWINGS

FIG. 1 shows schematically single capsule camera system in the GI tract.

FIG. 2 shows a flow chart of stabilizing the motion and luminance fluctuations.

FIG. 3 shows a flow chart of steps for estimating parameters of motion fluctuation.

FIG. 4 shows schematically a tubular object model for a capsule camera in the GI tract.

FIG. 5 shows the hierarchical blocks of two neighboring frames used for a hierarchical block motion estimation algorithm.

FIG. 6 shows a exemplary motion trajectory in the x direction along with the smoothed trajectory and the differences between the two trajectories.

FIG. 7 shows two consecutive frames being display on a display window larger than the frame size.

FIG. 8 shows schematically single capsule camera system in the GI tract where a polyp is present.

FIG. 9 shows stitched frames forming a panoramic view and being display on a display window larger than the stitched size.

FIG. 10a shows a panoramic capsule camera system having two cameras located at opposite sides inside the capsule enclosure.

FIG. 10b shows a panoramic capsule camera system having a single camera with a mirror to project a wide view onto the image sensor inside the capsule enclosure.

FIG. 10c shows an alternative panoramic capsule camera system having a single camera with a mirror to project a wide view onto the image sensor inside the capsule enclosure.

FIG. 11 shows a flow chart of luminance stabilization.

FIG. 12 shows an exemplary system block diagram using a computer workstation to implement the motion and luminance stabilization.

FIG. 13 shows exemplary computer system architecture to implement motion and luminance stabilization.

### DETAILED DESCRIPTION OF THE INVENTION

The capsule video in the present invention has different characteristic from the video if U.S. Pat. No. 7,119,837 in a number of respects. Firstly, the capsule camera operates in a dark environment where the illumination is supplied entirely by the camera. An entire frame may be exposed simultaneously by flashing the illumination during the sensor integration period, where the illumination source may use LED or other energy efficient light source. Secondly, due to the short distance between the camera and the organ surface to be imaged, the camera always has a wide field of view that causes the image distortion. Thus, affine transformations do not adequately describe the affect of camera motion. The current invention further warps the image to damp the warping that arises from the combination of camera motion and camera distortion. Thirdly, because the camera jitter is at times large and the frame rate is slow, stitching across frames is not always possible. Instead, the image frame is allowed to translate, rotate, and otherwise warp within an image field.

The current invention also varies the playback frame rate as a function of uncompensated camera motion so that a diagnostician may find anomalies or other points of interest as quickly and efficiently as possible. Variations in image luminance resulting from illumination variation are damped in the present invention as well. Peristaltic contractions of the intestine may be compensated. Image flaws resulting from specular reflection and/or transient exposure defects are eliminated by interpolation of the optical flow.

Most cameras are designed to create an image with a perspective that is a projection onto a plane. Camera distortion represents a deviation from this ideal planar perspective and may be compensated with post processing using a model of the camera obtained by camera calibration. In the absence of distortion, affine transformations completely describe the impact of camera motion on the image if the scene is a plane. If the scene is non-planar then parallax is also introduced by camera motion which is not compensated by affine transformations. However, in most cases, global motion compensation using affine transforms is still a big aesthetic improvement.

With in vivo imaging using a wide-angle or panoramic camera, the distortion of the camera is large and the object imaged is highly non-planar. In the case of a panoramic camera, a plane-projected perspective is not possible. A cylindrical projection is a natural choice. For a fish-eye lens, a spherical projection is most natural.

In order to stabilize the video with respect to camera motion, we estimate the motion of the camera relative to the object. We then warp the image to damp the optical flow resulting from camera motion. Ideal stabilization is obtainable if complete 3D information is obtained about the object imaged and the motion of the camera. In the absence of this information, we may still utilize prior knowledge about the geometry of the camera and in vivo environment to improve the stabilization algorithm.

The small bowel and colon are essentially tubes and the capsule camera is a cylinder within the tube. The capsule is on average aligned to the longitudinal axis of the organ. The colon is less tubular than the small bowel, having sacculations. Also, the colon is larger so the orientation of the capsule is less well maintained. However, to first order, the object imaged can be modeled as a cylinder in either case. This is a much better approximation than modeling it as a plane. The cylindrical approximation makes particular sense for a capsule with side facing cameras, such as a single panoramic objective, a single objective that rotates about the longitudinal axis of the capsule, or a plurality of objectives facing in different directions that together capture a panorama. In these cases, the camera will usually not capture a luminal view along the longitudinal axis. A luminal view may be longer range and might reveal the serpentine shape of the gut. A side-facing camera looks at a small local section which is better approximated as a cylinder than a longer section.

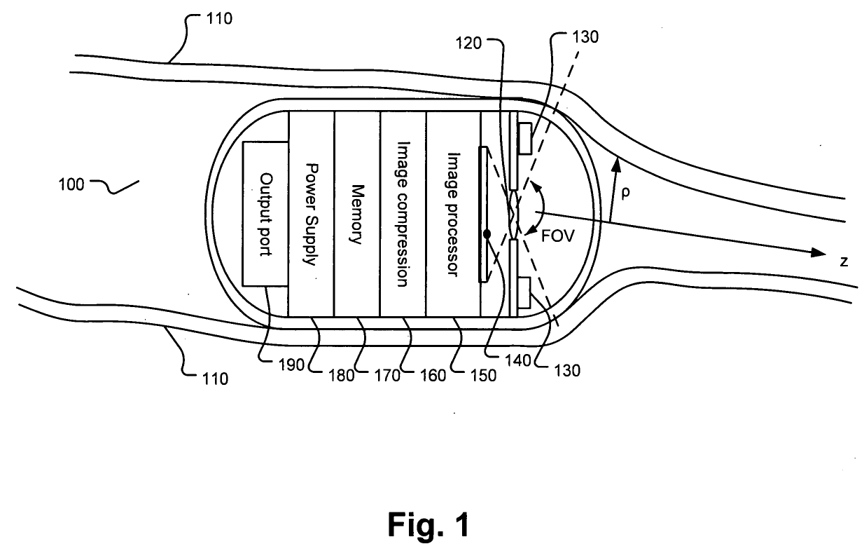

FIG. 1 illustrates a capsule camera with luminal view in the small bowel 110. The capsule camera 100 includes Lens 120, LEDs 130, and sensor 140 for capturing images. The capsule camera also includes Image processor 150, Image compression 160, and Memory 170 which work together to convert the captured images to a form suited for sending to an external receiving/viewing device through the Output port 190. The output port may comprise a radio transmitter transmitting from within the body to a base station located outside the body. It may instead comprise a transmitter that transmits data out of the capsule after the capsule has exited the body. Such transmission could occur over a wireline connection with electrical interconnection made to terminals within the capsule, after breaching the capsule housing, or wirelessly using an optical or radio frequency link. The capsule camera is self powered by Power supply 180.

During peristalsis, the bowel may contract and “pinch off” at either or both ends of the capsule. In the large bowel the organ will periodical constrict about the capsule, and then dilate. The motion of the small bowel or colon may be damped on video playback along with that of the capsule. The surface may be modeled as a tube of circular cross section where the radius ρ of the circle varies along the z axis, which is along the direction of the cylindrical axis. ρ(z) may be parameterized with a power series in z. For example, a second order approximation may be represented as: ρ(z)≅ρ₀+ρ₁z+ρ₂z². As will be understood by those skilled in the art, a different order of power series may be used to approximate ρ(z). In order to compensate the bowels movement, ρ(z) must be determined self consistently with the parameters of capsule motion relative to the bowel. The origin of the coordinate system would typically be located within the capsule, either at the pupil of a camera within the capsule or at a point along the longitudinal axis of capsule.

Camera motion produces changes in scene illumination since the illumination source moves with the camera. Over the course of a few frames, the LED control normalizes illumination across the FOV. However, sudden movements may cause transient changes in illumination that reduce viewability. The change in average luminance should be ignored when comparing blocks during motion estimation. Moreover, specular reflections, which are generally much brighter than diffuse reflections (those that arise from the scattering of light within tissues), may fluctuate dramatically from frame to frame with small changes in the inclination of mucosal surfaces relative to the camera. Imaged specular reflections usually contain saturated pixel signal (luminance) values. The motion estimation algorithm should ignore the neighborhood of specular reflections in both the current and reference frames during motion estimation.

Light from illumination sources may directly or indirectly, after reflecting from an object within the capsule, reflect from the capsule housing (the camera window) into the camera pupil and produce a “ghost” image. These ghost images always appear in the same location, although their intensity may vary with illumination flux. Image regions with significant ghost images may be excluded from the global motion calculation.

After the global motion has be stabilized (i.e. damped) the luminance of the image is also damped. Also, specular reflections and ghosts are, to the extent possible, removed by frame interpolation.

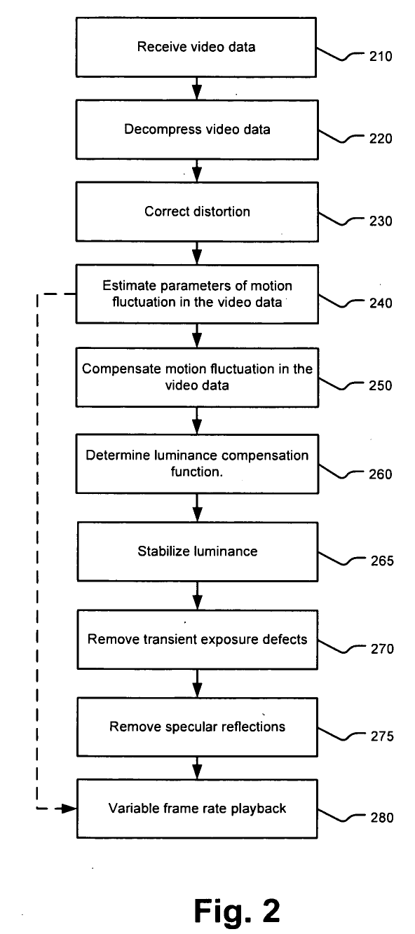

FIG. 2 illustrates a flow chart of the overall process for compensating motion fluctuation and luminance fluctuation. The capsule video is first received by the Receive video data block 210 and then decompressed by the Decompress video data block 220. An optional distortion correction may be performed by block 230 where the distortion is corrected by projecting (warping) both the image and the motion vector field (if recovered) onto an imaginary image surface using a model of the camera that may include calibration data. The image surface is typically a cylinder or sphere for a panoramic camera and a sphere for a very wide-angle camera.

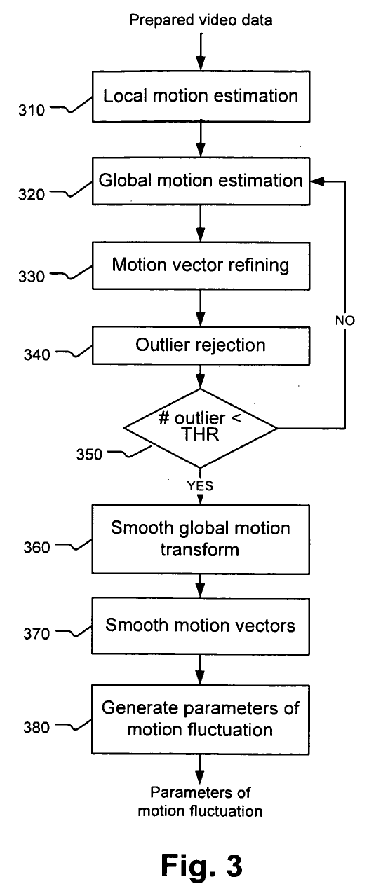

Upon the completion of the optional distortion correction, the video data go through estimating parameters of motion fluctuation in block 240, where the details are described in FIG. 3. The estimated parameters of motion fluctuation are then applied to compensate motion fluctuation in block 250. Also the estimated parameters of motion fluctuation may be used to control the frame rate during video playback in block 280.

The present invention not only compensates motion fluctuation, but also compensated luminance fluctuation and related luminance artifacts. In order to compensate luminance, a luminance compensation function is first computed in block 260 and the luminance compensation function is then used to stabilize luminance or compensate luminance 265. Various luminance artifacts are also removed including transient exposure defects 270 and specular reflection 275. The flow chart in FIG. 2 illustrates one embodiment of the present invention, where the luminance stabilization is performed first and is then followed by transient exposure defects removal and specular reflections removal. As will be understood by those skilled in the art, the ordering of the processing may be altered to provide the same effect of enhancement.

The present invention also takes advantage of the knowledge of motion parameters estimated during the process and applies the knowledge to controlling the play back frame rate 280 for accelerated viewing with minimum impact on diagnostician's capability to identify anomalies or areas of interest.

The process of estimating parameters of motion fluctuation is described with the help of FIG. 3. It is desirable to estimate global motion and use the estimated parameters to compensate the motion fluctuation. Since the primary fluctuation in the captured video is caused by camera movement including pitches, rolls, and yaws, global motion should render a more accurate movement model for the captured video. However, the global motion transformations are nonlinear for a non-planar image surface and scene, which makes optimizing the match over the entire multidimensional parameter space more difficult than if linear affine global transformations could be used. It may not be possible to determine the global transforms as a first step. Rather, the image motion is first analyzed using hierarchical block matching (e.g. as described in a paper by M. Bierling, entitled “Displacement estimation by hierarchical block-matching”, SPIE Vol. 1001 Visual Communications and Image Processing, 1988). While the hierarchical block motion estimation is used in the present invention for local motion estimation, as will be understood by those skilled in the art, many different algorithms are possible to estimate the local motion within a frame.

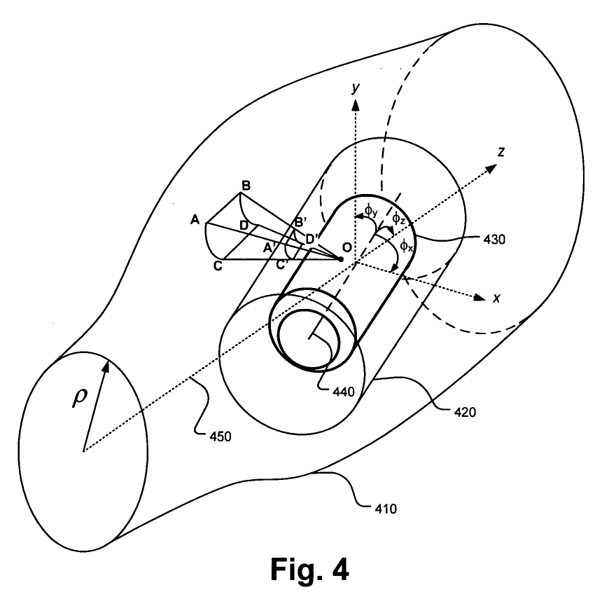

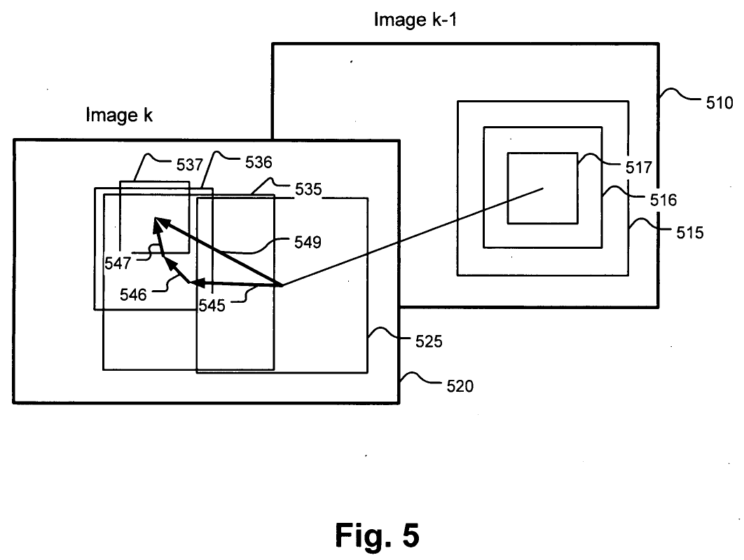

The motion estimation includes both global motion estimation and local motion estimation. The Local image estimation 310 divides image into blocks, where “block” refers to a neighborhood that may or may not be rectangular. A tubular object model is used for the cylindrical shaped GI tract as shown in FIG. 4. The particular local motion estimate used is further described with the illustration in FIG. 5. Block displacements from frame k-1 510 to frame k 520 are estimated recursively, starting with a large block size and progressing to a small block sizes. In each step in the recursion, the estimate for the larger previous block is used as an initial guess for the smaller current block. FIG. 5 illustrates the scenario that the initial blocks used in this example are 515 and 525. After the first iteration, the best match corresponding to block 515 in frame k-1 is found to be the block 535 in frame k resulting in estimated motion vector 545. In the next iteration of motion search, the block size is reduced and the initial search location is centered at the previous best match block 535. This example shows the subsequent best matched blocks are blocks 536 and 537 in frame k corresponding to blocks 516 and 517 in frame k respectively resulting in estimated motion vectors 546 and 547 respectively. The final estimated motion vector 549 and the vector summation of 545, 546 and 547. This example provides an illustration with block translations only. However, general affine transforms could be used at the higher levels of the hierarchy with the dimensionality reduced to translation alone at the bottom level of the hierarchy. The algorithm illustrated is one embodiment, where the local estimation algorithm is initially used and then it is combined with a global motion algorithm iteratively to refine the motion estimation. As will be understood by those skilled in the art, many different algorithms are possible to derive the motion information.

This and similar techniques take advantage of the relative spatial homogeneity of the motion vector field m(i, j, k) to improve the accuracy and reduce the computational effort of motion-vector estimation. Various known techniques for motion vector calculation are applicable. Motion vector estimation in the context of a capsule camera is discussed in patent application U.S. Ser. No. 11/866,368 assigned to Capso Vision, and this patent application is incorporated by reference herein in its entirety. A block in one frame is compared for similarity to blocks within a search area in prior or subsequent frames. The best match may be deduced by minimizing a cost function such as the sum of absolute differences (SAD).

The outputs from any of the levels in the block matching hierarchy can be used as inputs to global-motion estimation 320. Any motion vector field recovered from video compression decoding may also used as an input to global motion estimation or to the hierarchical block matching. FIG. 3 shows that the result of Global motion estimation 320 is used for Motion vector refining 330. The global motion estimate may then be fed back to the hierarchical block matching for refinement. Iterating between the global motion estimation and block matching improves motion estimation accuracy. The iterative process terminates when a stop criterion is satisfied and the example shown in FIG. 3 is the test in block 350 for whether the number of outliers is smaller than a pre-set threshold THR. Other stop criteria could also be used. For example, the stop criterion could be that the SAD for the for the frame-to-frame motion estimation is below a threshold. As will be understood by those skilled in the art, other stop criterion may also be used to achieve similar goal.

Outlier rejection 340 eliminates block motion vectors refined by Motion vector refining 330 that are not likely to represent global motion or will otherwise confound global motion estimation. Outlier vectors may reflect object motion in the scene that does not correspond to the simplified organ motion model. For example, a meniscus may exist at the boundary of a region over which the capsule is in contact with the moist mucosa. The meniscus moves erratically with either capsule or colon motion. Matching blocks that contain meniscus image data will not generally yield motion vectors that correlate with global motion.

Various criteria for outlier rejection are well known in the field. Blocks are compared to the block at the location in the reference frame that the motion vector points to. If the blocks contain essentially the same image date, the difference between the two blocks is small. The matching error may be quantified as the sum of absolute differences (SAD). Vectors above an SAD threshold are rejected, and the threshold is iterated to find the group of motion vectors that yields the best global motion estimation. Motion vectors are also rejected if they differ by more than some threshold value from the average value of their neighbor pixels. Other outlier criteria include rejection of edge vectors, rejecting vectors corresponding to blocks with saturated pixels, rejecting vectors corresponding to blocks with low intensity variance, and rejecting large motion vectors. After outlier rejection and the iterative process terminates, the Motion vector smoothing 370 and Global motion transform smoothing 360 are applied. The parameters of motion fluctuation corresponding to the difference between estimated motion parameters and smoothed motion parameters are computed in block 380.

The global motion transformations correspond to rotation and translation of the capsule relative to the organ in which it resides and also to changes in the organ diameter as a function of longitudinal distance in the vicinity of the capsule. FIG. 4 illustrates the model on which the global motion transforms are based. The organ 410 is modeled as a tube with radius ρ(z) along a straight axis z. The intestine is actually serpentine but can be modeled as straight in the vicinity of the capsule 430 where the axis 450 is the organ axis. The radius ρ(z) is a function along the organ axis direction and may be expanded as a power series in z. As mentioned previously, a second order approximation may be represented as: ρ(z)≅ρ₀+ρ₁z+ρ₂z².

The capsule containing one or more cameras is within the organ at a particular location and angle in the coordinate system of the organ. The camera forms images by projecting objects in its field of view onto the imaginary image surface 420. In this example the image surface is a cylinder concentric with the capsule where axis 440 is the capsule camera system axis. Often, the camera axis doesn't align with the organ axis. FIG. 4 shows a scenario that the capsule camera is tilt from the organ axis. The 3D angles φₓ, φ_{y}, and φ_{z} between the two axis are indicated in FIG. 4 by the corresponding arrows. A cylinder is a logical image surface for a panoramic camera. In FIG. 4, organ surface region ABCD is mapped onto the image surface as A′B′C′D′. If the capsule moves relative to the organ or if the organ changes shape, the shape and location of A′B′C′D′ on the image surface will change. To the extent that ABCD and A′B′C′D′ approximate planes, affine transforms may model their change of shape and motion. Global motion estimation consists of finding a self consistent set of parameters for change of organ shape and capsule position that is consistent with the change in the image. The change in image may be calculated as the vector field describing the motion of image regions or blocks such as A′B′C′D′.

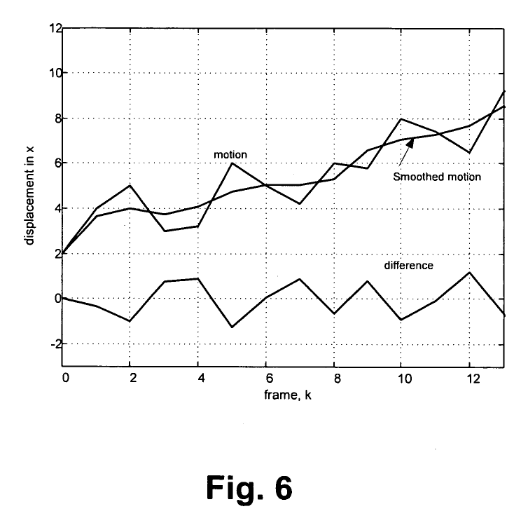

Camera motion includes both progressive motions down the GI tract, which must be preserved in the video, and jitter, which should be filtered out as much as possible. Let M(k) be the estimated global motion transformation, as a function of frame k. From M(k) a smoothed sequence of transformations \hat{M}(k) is determined that damps the motion of the image content within an image field. The video frame is contained within a larger image field such as a computer monitor or a display window on a monitor. These transformations produce position and shape fluctuations for the frame within the image field. These fluctuations must be constrained to have zero mean and to have amplitudes that keep the image entirely or at least substantially within the image field. It is not essential to restrict the rotation of the image since a rotating image will not leave the image field. Furthermore, unlike landscape images which normally have the sky up, in vivo images have no preferred rotational orientation. Moreover, the rotation of a circular image, such as that displayed by some capsule cameras, produces no change in the frame boundary location or shape. FIG. 6 plots an example of frame translation in the x direction, where the x-direction motion wanders around the smoothed x-direction motion. The net differences in the x-direction are shown in the bottom curve which has a zero mean.

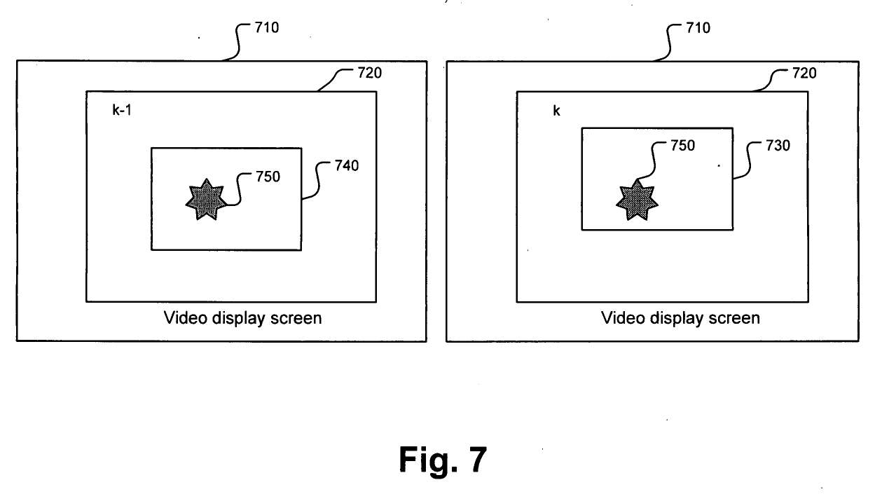

FIG. 7 shows an image of a star 750 in frame k-1 740 and in frame k 730. The star moves within the image from frame k-1 to k. In order to minimize the motion of the star in the image field or display window 720, the image is translated or motion compensated so that the image appears stationary within the display window 720. The display window 720 is larger than the image frames 730 and 740. The display window may occupy only part of a whole video display screen 710 as shown in FIG. 7. The effect is similar to viewing a scene through a hand-held aperture that is shaking due to the unsteadiness of the hand. As long as the scene is steady, limited motion of the aperture is not objectionable. In contrast, when binoculars are held, the entire image viewed jitters with hand motion and the affect is distracting. In order to eliminate motion of the image frame, the image could be cropped in each direction by an amount equal to the maximum image displacement. However, the reduction in image size may not acceptable and portions of the image that are significant may be cropped.

Motion within an image may be described in terms of the transformations of blocks rather than global transforms. Stabilization of the image is possible with a time-dependent (i.e. frame-dependent) warping that minimizes the high-frequency movement of features within the image field. A block-motion compensation field q(i, j, k)=\hat{m}(i, j, k)−m(i, j, k), where i and j are the block coordinates, k is the frame, and \hat{m}h(i, j, k) is a temporally smoothed version of m(i, j, k). m(i, j, k) may include the full set of affine transformations or a more limited set such as translation in x and y and rotation in φ. Each block of the image is moved an amount given by q(i, j, k). Since adjacent blocks may move by different amounts, the blocks are warped to preserve continuity at the boundaries. The grid defining blocks becomes a mesh with each block having curved boundaries. This block motion and warping is one means of determining the optical flow, or pixel motion. Other means are possible, such as interpolating the block motion vector field onto the grid of pixels, with appropriate smoothing.

In situations with large amounts of parallax, m(i, j, k) will be less homogeneous and may have spatial discontinuities. For example, when moving past a nearby tree, the tree moves across the image faster than its immediate background. In the intestine, the mucosa is a continuous surface. However, surface features such as folds and polyps may create occluded surfaces, at the boundaries of which, discontinuities in m(i, j, k) occur.

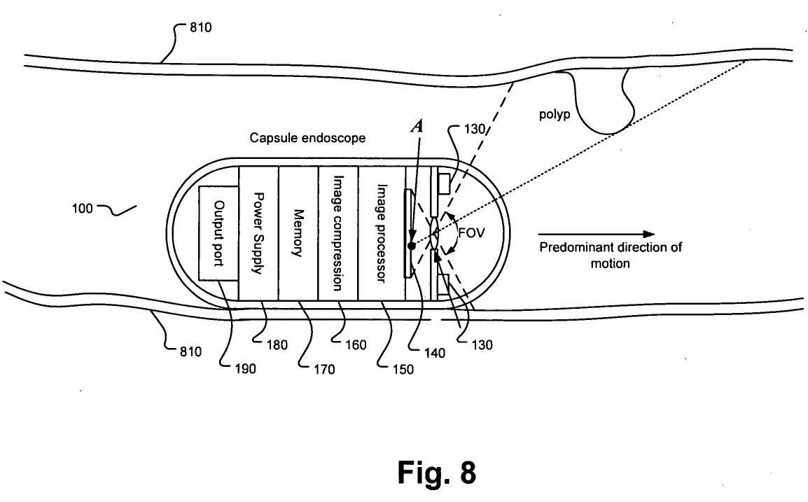

FIG. 8 illustrates a capsule camera 100 in the gut 810. A discontinuity occurs along a curve including point A on the image. As the capsule moves past the polyp, the occluded mucosa and polyp surfaces incrementally become visible, creating a discontinuity in the motion vectors at A in the image on the sensor. Since the occluded surfaces appear at different rates, discontinuity A moves across an image that is otherwise stabilized for camera motion. In order to avoid excessive warping of the polyp and its immediate surroundings, it may be desirable to reject outlying motion vectors and spatially low-pass filter q(i, j, k) (or, equivalently, \hat{m}(i, j, k) ), thereby minimizing the undesirable warping that would occur about the discontinuity. Outlier rejection also helps to minimize incorrect warping arising from erroneous motion estimations.

The amount of warping, like the amount of image translation or rotation, is small if the rate of change is slow. If the camera moves quickly, the image temporarily moves and warps to slow down the motion of features relative to the image field. Although image warping may not be acceptable in all applications, for in vivo imaging of the gut, we view objects that are amorphous and which have no a priori expected shape. In order to view a particular feature more carefully, the image stabilization can be disabled.

If the camera surges forward, motion vectors will radiate outwardly from the image center. The image displayed will temporarily expand in size to slow down the rate at which the size and position of features in the image field changes.

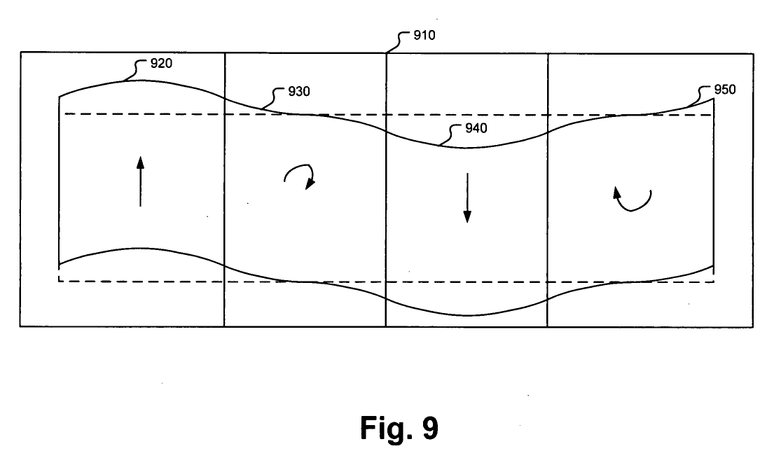

If a panoramic camera is tilted, the two portions of the image through which the rotation axis passes will rotate in opposite directions. One region of the image 900 from the rotation axis will move up and the region 1800 from that will appear to move down. FIG. 9 illustrates the warping of a panoramic image with image stabilization due to panoramic camera tilt. The nominal, average, shape of the image is shown in dashed lines. During rotation of the camera, the images 920, 930, 940 and 950 will warp to take on the shape shown with a solid line. After the camera tilt has stopped, the shape would return to a rectangular shape. The final image is the same, whether image stabilization is used or not. However, the movement of features within the image field or display window 910 is damped by image stabilization. Even more advantageously, if the camera tilts one way and then immediately tilts back again, the absolute motion of features within the image field is minimized by stabilization.

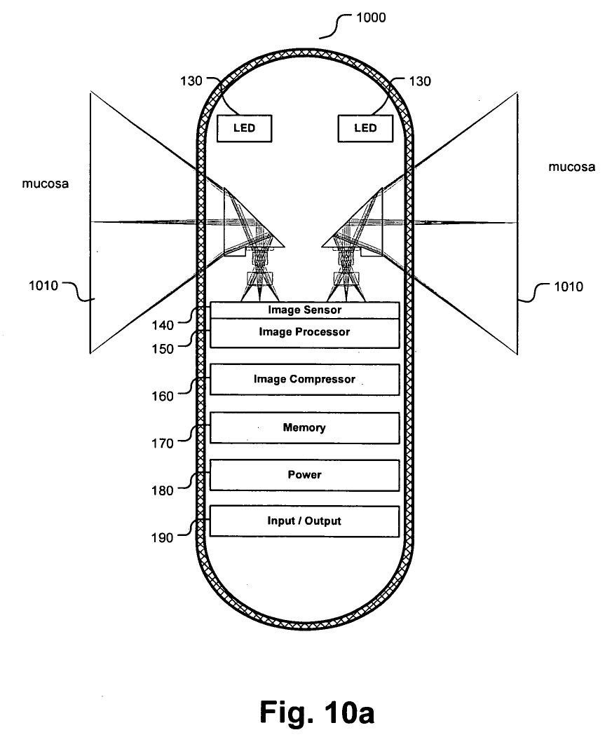

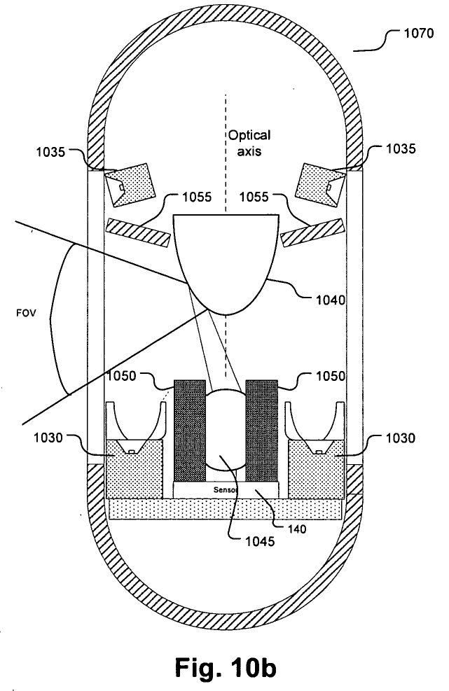

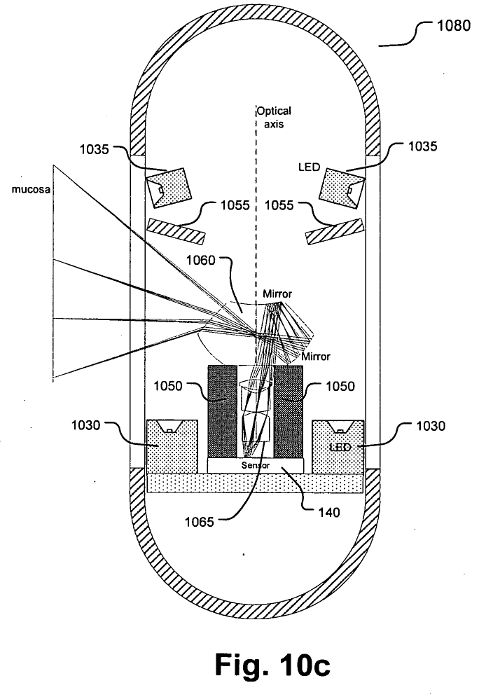

A capsule panoramic camera system having multiple capsule cameras is shown in FIG. 10a. A panoramic image may be formed by four cameras facing directions separated by 90°. FIG. 10 illustrates two of the four cameras which are oppositely facing, where the lens 1010 is used to for side-view imaging. The four images may be stitched together or presented side-by-side. Even if the images are not stitched into a single image, the impact of image-stabilization-with-warping on each individual image will be similar to that shown in FIG. 9. The leftmost image will bow upward. The next image to the right will rotate while maintaining approximately vertical sides that approximately match up with the adjacent image sides.

A capsule panoramic camera system 1070 having a single camera is shown in FIG. 10b. A cone-shaped mirror is used to project a wide view of the object onto the image sensor 140 through the lens 1045 hosted in the lens barrel 1050. In order to direct the light from LEDs 1030 to the object being imaged, annular mirror 1055 is used. LED lead-frame package 1035 is also used to add more light to cover wide imaging area. An alternative panoramic camera system 1080 using a single camera is shown in FIG. 10c where the mirror 1060 and the lens 1065 have different structure from those used in FIG. 10b.

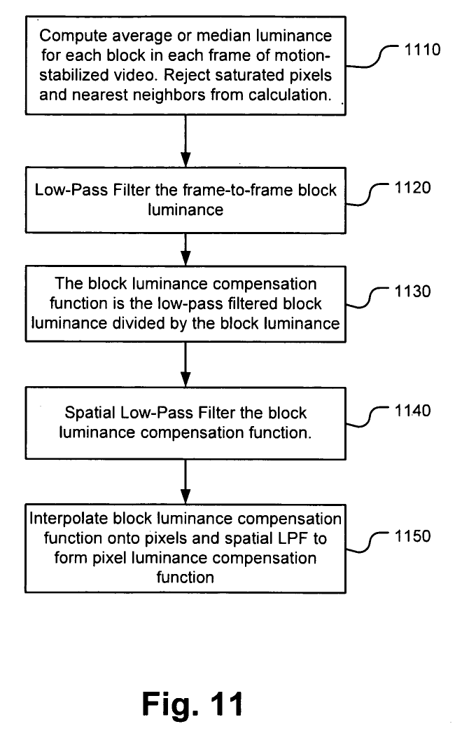

The changes in image luminance due to changes in illumination may be smoothed out in the motion stabilized video by applying a space- and time-dependent gain function that lightens or darkens regions of the image field to dampen fluctuations in luminance. Changes in scene illumination affect pixel luminance values only, not chrominance. We divide the stabilized image into blocks or neighborhoods. The process for luminance stabilization is shown in the flow chart of FIG. 11. Let the average or median block luminance for block (i,j) in frame k be v(i, j, k) and the value is calculated in block 1110. Saturated pixels and their immediate vicinity are excluded from the calculation. A temporally smoothed version \hat{v}(i, j, k) of v(i, j, k) after outlier rejection is calculated in block 1120. Then the block luminance compensation function g (i, j, k)=\hat{v}(i, j, k)/v(i, j, k) is a compensation gain as a function of block is calculated in block 1130. The block luminance compensation function is then spatially low-pass filtered in block 1140 and then interpolate g(i, j, k) in block 1150 onto the grid of pixels and low-pass filter again to produce the pixel luminance compensation function gₚᵢₓₑₗ(m, n, k), where m and n are the pixel coordinates. The new pixel values are then the current values multiplied by gₚᵢₓₑₗ(m, n, k).

Specular reflections fluctuate even with small movements of the capsule or colon. The reflections are bright and usually will saturate pixels. Pixels at the edge of a specular reflection may not saturate, and specular reflections from some objects such as bubbles may be bright but not saturating. A feature in the scene may produce a specular reflection in one frame but not in the frame before or after. After motion detection, we may interpolate across frames to estimate the image data at the location of the specular reflection and replace the saturated or simply bright pixels with the interpolated pixels.

The same procedure may be applied to pixels that saturate due to overexposure that does not arise from specular reflection. The fluctuation in illumination will sometimes drive regions of the image into saturation. Luminance stabilization cannot compensate for saturation. Likewise, the image quality of highly over-exposed or under-exposed regions is not improved by luminance stabilization. Luminance stabilization merely removes the distraction of fluctuating luminance. The quality is improved by interpolating across frames to replace over- or under-exposed pixels.

In order to replace individual pixels, we must compute optical flow vectors that indicate the trajectory of pixels from one frame to the next. The optical flow can be calculated by interpolating the block motion vectors onto the pixels. The average may be weighted in part by the SAD calculated for each motion vector so that poorer block matches are less heavily weighted than good ones. A block corrupted by specular reflections may not connect via a motion vector to the prior or subsequent frame. We must interpolate the optical flow vector fields across multiple frames and over an extended region in the neighborhood of the flaw to fill in the missing pixels with the best estimate.

The present invention provides special features based on estimated motion parameters during play video, including:

1. The frame rate of the display is a function of \hat{m}(i, j, k) or \hat{M}(k) such that the frame rate is reduced as the uncompensated image content motion increases. This contrasts with prior art control of display frame rate.

2. If the frame rate is reduced below a threshold by a user control such as a mouse or joy stick, the image stabilization and/or luminance stabilization could automatically turn off.

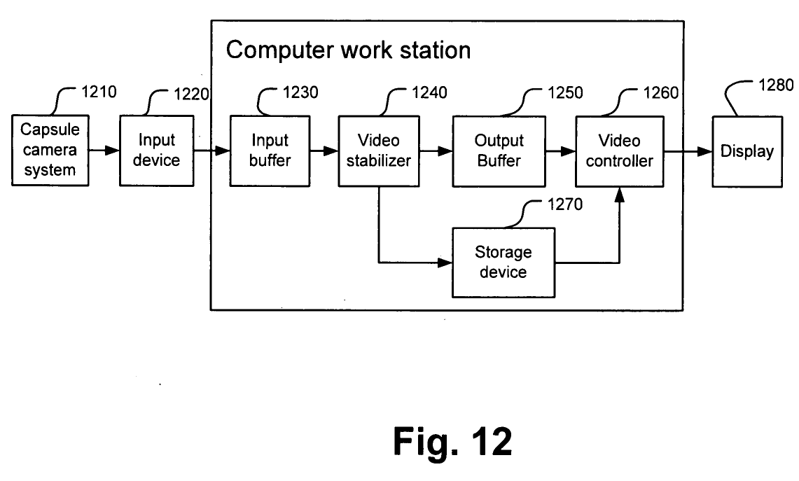

Computation of the stabilization parameters may be calculated during the upload of images from the capsule. The display of images may also commence before the upload is complete. The pipeline is illustrated in FIG. 12. The video stabilizer 1240 comprises the computer processor and memory and may also include dedicated circuitry. As segments of video from Capsule camera system 1210 through Input device 1120 and Input buffer 1230 are stabilized, the frames are placed in Output buffer 1250 and then transferred to Video controller 1260 and then to Display 1280. The video is also passed to Storage device 1270 and may be replayed from there at a later time. The video controller, which includes memory, controls functions such as display frame rate, rewind, and pause. Since the frame rate is slower than the upload rate, the controller will retrieve frames from the storage device once the output buffer is full. The video may be displayed as part of a graphical user interface which allows the user to perform functions such as entering annotation, saving and opening files, etc.

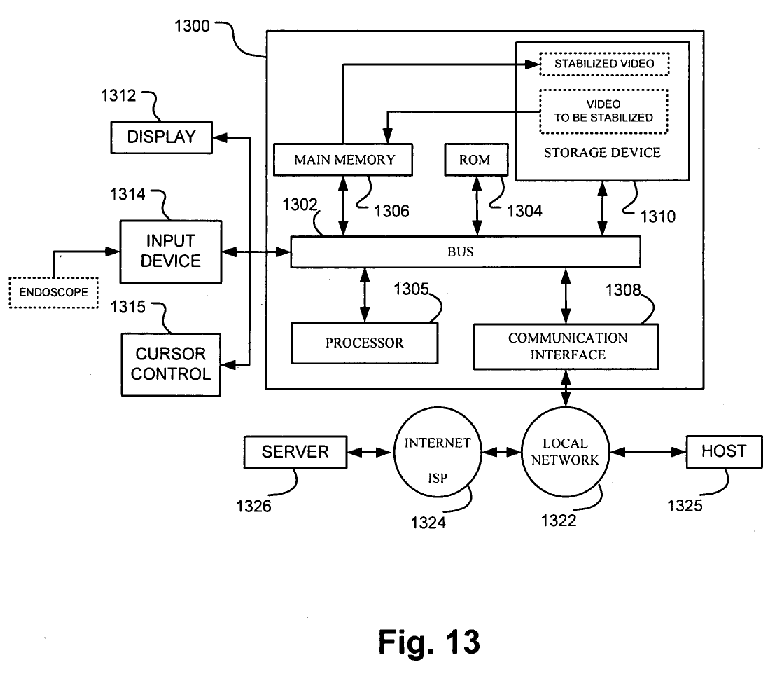

The stabilization methods described herein operate on a computer system 1300 of the type illustrated in FIG. 13 which is discussed next. Specifically, computer system 1300 includes a bus 1302 (FIG. 13) or other communication mechanism for communicating information, and a processor 1305 coupled with bus 1302 for processing information. Computer system 1300 also includes a main memory 1306, such as a random access memory (RAM) or other dynamic storage device, coupled to bus 1302 for storing information and instructions to be executed by processor 1305.

Main memory 1306 also may be used for storing temporary variables or other intermediate information during execution of instructions to be executed by processor 1305. Computer system 1300 further includes a read only memory (ROM) 1308 or other static storage device coupled to bus 1302 for storing static information and instructions for processor 1305. A storage device 1310, such as a magnetic disk or optical disk, is provided and coupled to bus 1302 for storing information and instructions.

Computer system 1300 may be coupled via bus 1302 to a display 1312, such as a cathode ray tube (CRT), for displaying the stabilized video and other information to a computer user. An input device 1314, including alphanumeric and other keys, is coupled to bus 1302 for communicating information and command selections to processor 1305. Another type of user input device is cursor control 1316, such as a mouse, a trackball, or cursor direction keys for communicating direction information and command selections to processor 1305 and for controlling cursor movement on display 1312. This input device typically has two degrees of freedom in two axes, a first axis (e.g., x) and a second axis (e.g., y), that allows the device to specify positions in a plane.

Stabilization of images is performed by computer system 1300 in response to processor 1305 executing one or more sequences of one or more instructions contained in main memory 1306. Such instructions may be read into main memory 1306 from another computer-readable medium, such as storage device 1310. Execution of the sequences of instructions contained in main memory 1306 causes processor 1305 to perform the process steps. In alternative embodiments, hard-wired circuitry may be used in place of or in combination with software instructions to implement the invention. Thus, embodiments of the invention are not limited to any specific combination of hardware circuitry and software.

The term “computer-readable storage medium” as used herein refers to any storage medium that participates in providing instructions to processor 1305 for execution. Such a storage medium may take many forms, including but not limited to, non-volatile media, volatile media. Non-volatile media includes, for example, optical or magnetic disks, such as storage device 1310. Volatile media includes dynamic memory, such as main memory 1306.

Common forms of computer-readable storage media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, as described hereinafter, or any storage medium from which a computer can read.

Various forms of computer readable storage media may be involved in carrying to processor 1305 for execution, one or more sequences of one or more instructions to perform methods of the type described herein, e.g. as illustrated in FIGS. 2, 3 and 4. For example, the instructions may initially be carried on a magnetic disk of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1305 retrieves and executes the instructions. The instructions received by main memory 1306 may optionally be stored on storage device 1310 either before or after execution by processor 1305.

Computer system 1300 also includes a communication interface 1315 coupled to bus 1302. Communication interface 1315 provides a two-way data communication coupling to a network link 1320 that is connected to a local network 1322. Local network 1322 may interconnect multiple computers (as described above). For example, communication interface 1315 may be an integrated services digital network (ISDN) card or a modem to provide a data communication connection to a corresponding type of telephone line. As another example, communication interface 1315 may be a local area network (LAN) card to provide a data communication connection to a compatible LAN. Wireless links may also be implemented. In any such implementation, communication interface 1315 sends and receives electrical, electromagnetic or optical signals that carry digital data streams representing various types of information.

Network link 1320 (not shown in FIG. 13) typically provides data communication through one or more networks to other data devices. For example, network link 1320 (not shown in FIG. 13) may provide a connection through local network 1322 to a host computer 1325 or to data equipment operated by an Internet Service Provider (ISP) 1326. ISP 1326 in turn provides data communication services through the world wide packet data communication network 1328 (not shown in FIG. 13) now commonly referred to as the “Internet”. Local network 1322 and network 1328 (not shown in FIG. 13) both use electrical, electromagnetic or optical signals that carry digital data streams. The signals through the various networks and the signals on network link 1320 (not shown in FIG. 13) and through communication interface 1315 (not shown in FIG. 13), which carry the digital data to and from computer system 1300, are exemplary forms of carrier waves transporting the information.

Computer system 1300 can send messages and receive data, including program code, through the network(s), network link 1320 and communication interface 1315. In the Internet example, a server 1350 might transmit a stabilized image through Internet 1328 (not shown in FIG. 13), ISP 1326, local network 1322 and communication interface 1315.

Computer system 1300 performs image stabilization on the video generating a new video that is stored on a computer readable storage medium such as a hard drive, a CD-ROM or a digital video disk (DVD) or using a format specific to a video display device not connected to a computer. This stabilized video could then be viewed on any video display device.

Alternatively, the stabilization might be performed real time as the video is displayed. Several frames would be buffered on which the stabilization computation would be performed. Modified stabilized frames are generated and placed in a buffer and then output to the display device which might be a computer monitor or other video display device. This real time stabilization could be performed using an ASIC, FPGA, DSP, microprocessor, or computer CPU.

1. A method of compensating motion fluctuation in video data from a capsule camera system, the method comprising:
receiving the video data generated by the capsule camera system;
arranging the received video data;
estimating parameters of the motion fluctuation of the arranged video data based on a tubular object model;
compensating the motion fluctuation of the arranged video data using the parameters of the motion fluctuation; and
providing the motion compensated video data as a video data output.

2. A method of claim 1, wherein the arranging step may include video decompression if the received video data is compressed.

3. A method of claim 1, wherein the arranging step may include image warp to correct distortion.

4. A method of claim 1, wherein the parameters of the motion fluctuation include a global motion component and a local motion component, wherein
the global motion component corresponds to deviations of global motion transforms from smoothed global motion transforms for the arranged video data, and
the local motion component corresponds to deviations of motion vectors from smoothed motion vectors for a frame of the arranged video data.

5. A method of claim 4, wherein the motion vectors are generated using a block matching algorithm for blocks of the frame corresponding to the local motion between the frame and a reference frame.

6. A method of claim 5, wherein the motion vectors generated for the frame are fed to a global motion estimation algorithm using the tubular object model to derive the global motion transform between the frame and the reference frame.

7. A method of claim 6, wherein the global motion transform is used for refining the motion vectors and the refined motion vectors may be fed to the global motion estimation algorithm using the tubular object model for updating the global motion transform.

8. A method of claim 7, wherein the refining and updating are repeated until a stop criterion is satisfied and a converged global motion transform and converged motion vectors are generated.

9. A method of claim 8, wherein the motion vectors are refined by using an optical flow vector model and the global motion transform.

10. A method of claim 9, wherein outlier motion vectors are identified and rejected.

11. A method of claim 8, where the stop criterion is based on number of the outlier motion vectors.

12. A method of claim 8, wherein the converged global motion transforms for the arranged video data are smoothed according to a temporal smoothing algorithm.

13. A method of claim 12, wherein smoothed motion vectors are generated by using an optical flow vector model and the smoothed global motion transform.

14. A method of claim 6, wherein the global motion transform includes dependency on 3D location (x, y, z), 3D angles (φₓ, φ_{y}, φ_{z}), and power series approximation coefficients (ρ₀, ρ₁, and ρ₂) of z(ρ).

15. A method of claim 4, wherein the local motion component of the motion fluctuation estimated is used to compensate the motion fluctuation within a frame of the arranged video data.

16. A method of claim 4, wherein the global motion component of the motion fluctuation estimated is used to compensate the motion fluctuation across frames of the arranged video data.

17. A method of claim 15, wherein the compensating the motion fluctuation within the frame is performed on a pixel basis by warping and using an optical flow model for the local motion component of the motion fluctuation.

18. A method of claim 15, wherein the compensating the motion fluctuation within the frame is performed on a pixel basis by spatially interpolating the local motion component of the motion fluctuation for each pixel of the frame.

19. A method of claim 15, wherein a display window area larger than the frame is used for the compensating the motion fluctuation.

20. A method of claim 15, wherein the capsule camera system includes a panoramic camera having a plurality of cameras and the arranged video data is viewed in a panoramic fashion.

21. A method of claim 15, wherein the capsule camera system includes a panoramic camera having a single camera.

22. A method of claim 20, wherein a factor of the panoramic camera tilt is incorporated into the compensating the motion fluctuation, wherein each of the cameras is tilted in a respective direction of the camera.

23. A method of claim 22, wherein a window area larger than stitched frames of the arranged video data is used.

24. A method of claim 1, wherein the providing the motion compensated video data includes luminance stabilization, wherein the luminance stabilization identifies luminance variations between the motion compensated video data and a spatial-temporal luminance conditioned version of the motion compensated video data, and compensates the luminance variations accordingly.

25. A method of claim 24, wherein saturated pixels and neighboring pixels are excluded from generating the spatial-temporal luminance conditioned version, and steps of the generating the spatial-temporal luminance conditioned version include average or median luminance of a block in a frame of the motion compensated video data, and low-pass filtering of corresponding blocks over a plurality of frames of the motion compensated video data.

26. A method of claim 24, wherein the luminance variations are computed as a block luminance compensation function as being a ratio of the spatial-temporal luminance conditioned version of the motion compensated video data and the motion compensated video data on a block basis, the block luminance compensation function is subject to spatial low-pass filter, the filtered block luminance compensation function is spatially filtered to obtain a pixel luminance compensation function and the luminance variations are compensated by multiplying the motion compensated video data by the pixel luminance compensation function on a pixel by pixel basis.

27. A method of claim 1, wherein the providing the motion compensated video data includes removing transient exposure defects.

28. A method of claim 1, wherein the providing the motion compensated video data includes removing specular reflections.

29. A method of claim 1, wherein the providing the motion compensated video data includes providing a variable frame rate playback according to the parameters of the motion fluctuation.

30. A method of compensating motion fluctuation in video data from a capsule camera system, the method comprising:
receiving the video data generated by the capsule camera system, wherein the video data consists of frames with a frame size;
estimating parameters of the motion fluctuation of the received video data;
compensating the motion fluctuation of the received video data using the parameters of the motion fluctuation; and
providing the motion compensated video data in a display window larger than the frame size.

31. A system for compensating motion fluctuation in video data from a capsule camera system comprising:
an input interface coupled to the video data generated by the capsule camera system;
a video processor coupled to the video data and configured to estimate parameters of the motion fluctuation in the video data based on a tubular object model and to compensate the motion fluctuation in the video data using the estimated parameters of the motion fluctuation; and
an output interface coupled to the motion compensated video data and to render a video data output.

32. A system for compensating motion fluctuation in video data from a capsule camera system comprising:
an input interface coupled to the video data generated by the capsule camera system, wherein the video data consists of frames with a frame size;
a video processor coupled to the video data and configured to estimate parameters of the motion fluctuation in the video data based and to compensate the motion fluctuation in the video data using the estimated parameters of the motion fluctuation; and
an output interface coupled to the motion compensated video data and to render a video data output with a display window larger than the frame size.
